(19) United States
(12) Patent Application Publication
(10) Pub. No.: US 2002/0073409 A1
(43) Pub. Date: Jun. 13, 2002

(54) Telecommunications platform with processor cluster and method of operation thereof

(76) Inventors: Arne Lundback, Skogas (SE); Rolf Eriksson, Stockholm (SE); Staffan Larsson, Tyreso (SE); Mats Nilsson, Stockholm (SE)

Correspondence Address: NIXON & VANDERHYE P.C., 8th Floor, 1100 North Glebe Road, Arlington, VA, 22201-4714, US

(21) Appl. No.: 09/734,707

(22) Filed: Dec. 13, 2000

(51) Int. Cl. G06F 9/44

(52) U.S. Cl. 717/170; 717/171

(57) ABSTRACT

A telecommunications platform (20) comprises a cluster (32) of processors (30) which perform a platform central processing function. The platform central processing function includes a cluster support function (50) which is distributed to the cluster of processors. For sake of redundancy, programs (PGMs) are distributed throughout the cluster so that at least some of the processors of the cluster have active versions of at least some of the programs and standby versions of others of the programs, e.g., an intermixing of assignments of active and standby versions of programs. Moreover, programs and programs comprising them can be loaded, started, shutdown, stopped, and upgraded without terminating overall operation the platform. In its various aspects, the cluster support function (50) includes a state storage system (200) and a name server system (300) for facilitating restart and switch over of programs and programs executed by processors of the cluster.

### BACKGROUND

This application is related to U.S. patent application Ser. No. 09/467,018 filed Dec. 20, 1999, entitled “Internet Protocol Handler for Telecommunications Platform With Processor Cluster”, as well as to the following simultaneously-filed United States Patent Applications: U.S. Pat. application Ser. No. 09______ (attorney docket: 2380-180), entitled “Software Distribution At A Multi-Processor Telecommunications Platform”; and U.S. patent application Ser. No. 09/______ (attorney docket: 2380-183), entitled “Replacing Software At A Telecommunications Platform”, all of which are incorporated herein by reference.

1. Field of the Invention

The present invention pertains to platforms of a telecommunications system, and particularly to such platforms having a multi-processor configuration.

2. Related Art and Other Considerations

In multi-processor environments robustness and redundancy is typically attempted by various techniques. One technique is to provide passive standby processors which are prepared to take over a task from another processor in the event of failure. In such technique, the passive standby processor performs essentially no useful work at all. The redundancy afforded by this technique can be of a n+1 type; an n+m type, or an n+n type. In an n+1 system, there is only one standby processor present to take over the load from another other processor of the system. In an n+m type system, a pool of standby processors is provided which are utilized one after the other in serial fashion until the pool is empty. In an n+n system, there is one dedicated standby processor paired with each active processor and which takes over the load from its paired processor when there is a failure or problem. The standby processors can be in either a hot or cold standby mode in accordance with how long it takes the standby processor to take over tasks from another processor.

Thus, a system of standby processors implies unused execution resources. None of the standby processors typically perform any useful work, even thought they will be running, at least in the hot standby case. The level of unused resources depends on the level of robustness. The more standby processors a system has, the greater the wasted processing power.

Another technique is to provide a pair of completely synchronized processors which perform the same tasks simultaneously, but with the result of the task being utilized from only one of the processors. Thus, in accordance with this synchronized technique, the two involved processors both execute the same instructions at the same time. In the case of failure of one of the pair of processors, the result from the non-failing processor is utilized. However, effective synchronization of pairs of processors requires some control or knowledge of processor design, and does not lend itself well to commercially available processors.

What is needed, therefore, and an object of the present invention, is a multi-processor platform that provides standby processing capability without wasting processing power.

### BRIEF SUMMARY OF THE INVENTION

A telecommunications platform comprises a cluster of processors which perform a platform central processing function. The platform central processing function includes a cluster support function which is distributed to the cluster of processors. For sake of redundancy, programs are distributed throughout the cluster so that at least some of the processors of the cluster have active versions of at least some of the programs and standby versions of others of the programs, e.g., an intermixing of assignments of active and standby versions of programs. Moreover, programs can be loaded, started, shutdown, stopped, and upgraded without terminating overall operation the platform.

In one aspect, the cluster support function includes a state storage system. An active version of a program executing on a first processor of the cluster stores state data in the state storage system. The state data is sufficient for a standby version of the program to resume operation (e.g., on another processor) should the active version of the program terminate, or for the same version of the program to restart. In the event one of upgrade or shutdown of the active version of the program, the another version of the program can be the standby version thereof which executes on a second processor of the cluster. The state data of the event-affected program is provided to the another (standby) version of the program for resumption of operation of the program.

The active version of an event-affected program sends its state data and a storage mode flag to the state storage system. Depending on its value, the storage mode flag requests storage in one of the following modes: (1) an IMMEDIATE REPLICATION mode (storing the state data in parallel in both a memory accessible by the first processor of the cluster and in a memory accessible by a second processor of the cluster); (2) a BACKGROUND REPLICATION mode (essentially immediate storing of the state data in a memory accessible by the first processor of the cluster followed by delayed storing of the state data in a memory accessible by a second processor of the cluster); or (3) a LOCAL mode (storing the state data in a non-volatile memory accessible by the first processor of the cluster). The application software is designed so that the application software itself knows what data needs to be stored in the state storage system, and which of the save modes is to be implemented for that particular program. Moreover, a program may utilize one or more of the storage modes.

The cluster support function also comprises a name server system. Upon publication of a design name of a server program, the name server system associates in its name server data base a run time reference (run time name) with the design name of the program and supervises presence of the program. A client can retrieve the run time reference (name) of the server program from the name server system for contacting and supervising a server program. Moreover, the name server system detects when the server program on a first processor has failed and has been moved from the first processor to a second processor. In such instance, the name server system removes the run time reference of the server program on the first processor from its data base, and the relocated server program obtains a new run time reference from the operating system. The client can then request the new run time reference of the server program from name server system, and smoothly continue operation.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a telecommunications platform having a main processor cluster according to an embodiment of the invention.

FIG. 2 is a schematic view of showing distribution of Cluster Support Function throughout the main processor cluster of FIG. 1.

FIG. 3 is a diagrammatic view of a load module.

FIG. 4 is a diagrammatic view illustrating loading of a load module to create programs in plural processors.

FIG. 5 is a diagrammatic view showing distribution of active and standby versions of programs through an example processor cluster of the invention.

FIG. 6 is a diagrammatic view showing issuance of start, shutdown, and upgrade messages from a cluster support function to various programs in accordance with the present invention.

FIG. 6A is a diagrammatic view showing issuance of start messages from a cluster support function to both an active program and a standby program in accordance with the present invention.

FIG. 6B is a diagrammatic view showing issuance of a further start message from a cluster support function to a standby program that takes over for an active program.

FIG. 7 is a schematic view showing a state storage system as being included in the Cluster Support Function of FIG. 2.

FIG. 7A is schematic view of a state storage system performing a save instruction in a save immediate mode.

FIG. 7B is schematic view of a state storage system performing a save instruction in a save background mode.

FIG. 7C is schematic view of a state storage system performing a save instruction in a save local mode.

FIG. 8 is a schematic view showing a name server system as being included in the Cluster Support Function of FIG. 2.

FIG. 8A is a schematic view showing a scenario of operation of the name server system of FIG. 8.

FIG. 9 is a diagrammatic view of a name table maintained by a name server system of the cluster support function, showing a correlation of design name and run time reference for programs executed by the main processor cluster of the invention.

FIG. 10 is a schematic view of one example embodiment of a ATM switch-based telecommunications platform having the cluster support function of the invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

In the prior art, many telecommunications platforms have a single powerful processor which serves as a central processing resource for the platform. The central processing resource provides an execution environment for application programs and performs supervisory or control functions for other constituent elements of the platform. For example, the central processing resource executes software which controls or manages software executed by local processors of the platform (e.g., board processors). The local processors can, for example, host software for local control of a dedicated hardware performing a certain task. The central processing resource is normally much more powerful than the local processing resources.

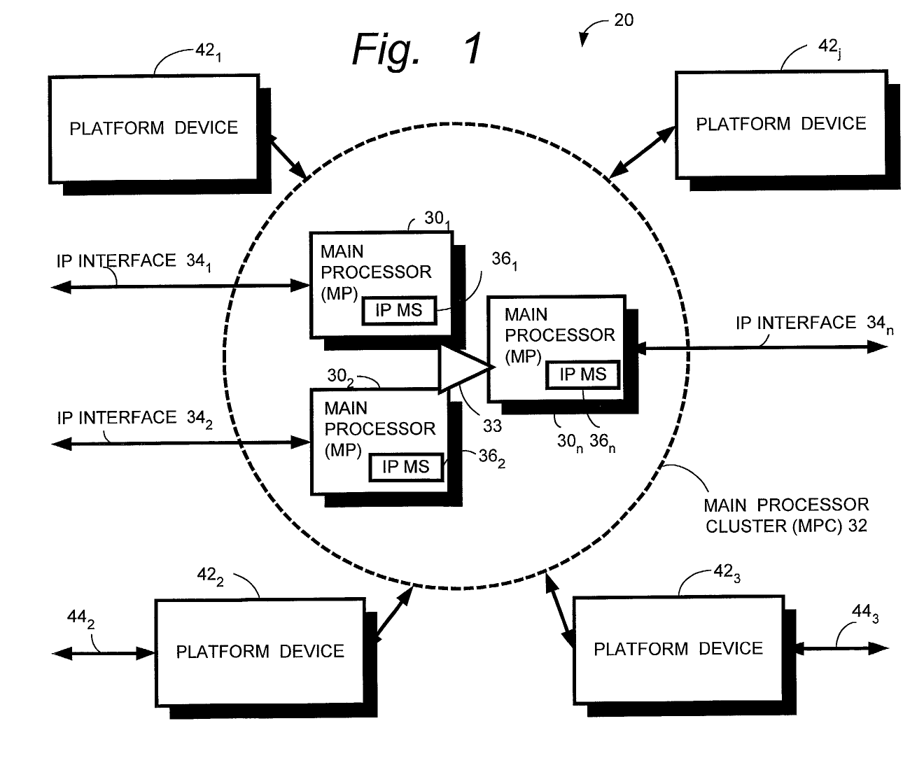

In contrast to a single central processor platform, FIG. 1 shows a generic multi-processor platform 20 of a telecommunications network, such as a cellular telecommunications network, for example, according to the present invention. The telecommunications platform 20 of the present invention has a central processing resource of the platform distributed to plural processors 30, each of which is referenced herein as a main processor or MP. Collectively the plural main processors 30 comprise a main processor cluster (MPC) 32. FIG. 1 shows the main processor cluster (MPC) 32 as comprising n number of main processors 30, e.g., main processors 30ₗ, through 30ₙ.

The main processors 30 comprising main processor cluster (MPC) 32 are connected by inter-processor communication links 33. The transport layer for communication between the main processors 30 is not critical to the invention. Furthermore, one or more of the main processors 30 can have an internet protocol (IP) interface 34 for connecting to data packet networks.

FIG. 1 shows j number of platform devices 42 included in telecommunications platform 20. The platform devices 42ₗ-42ⱼ can, and typically do, have other processors mounted thereon. In some embodiments, the platform devices 42ₗ-42ⱼ are device boards. Although not shown as such in FIG. 1, some of these device boards have a board processor (BP) mounted thereon for controlling the functions of the device board, as well as special processors (SPs) which perform dedicated tasks germane to the telecommunications functions of the platform.

Although not specifically illustrated as such, there are communication channels from all platform devices 42 to all main processors 30 over an intra-platform communications system. Examples of intra-platform communications system include a switch, a common bus, and can be packet oriented or circuit switched. In addition, there are communication channels (over inter-processor communication links 33) between all main processors 30 in the main processor cluster (MPC) 32.

Some of the platform devices 42 connect externally to telecommunications platform 20, e.g., connect to other platforms or other network elements of the telecommunications system. For example, platform device 422 and platform device 423 are shown as being connected to inter-platform links 442 and 443, respectively. The inter-platform links 442 and 443 can be bidirectional links carrying telecommunications traffic into and away from telecommunications platform 20. The traffic carried on inter-platform links 442 and 443 can also be internet protocol (IP) traffic which is involved in or utilized by an IP software application(s) executing in management service (IP MS) section 36 of one or more main processors 30.

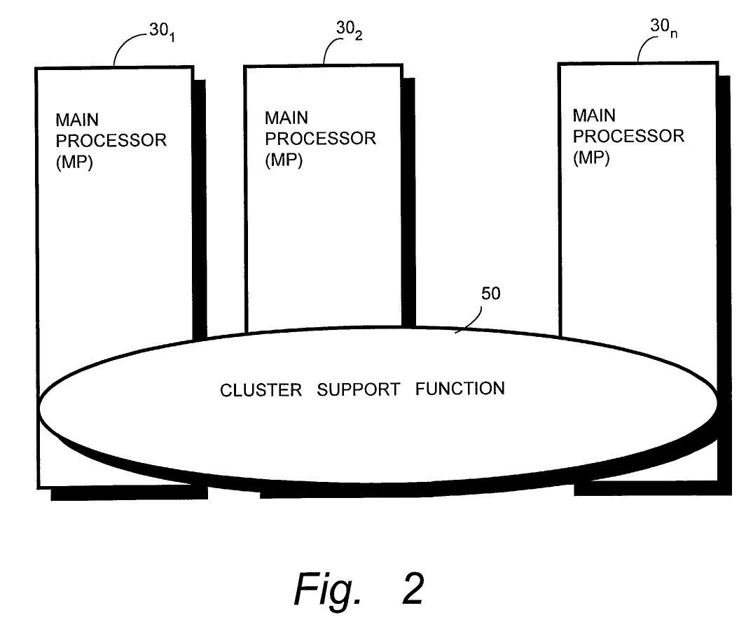

As shown in FIG. 2 and hereinafter described, main processor cluster (MPC) 32 has cluster support function 50 which is distributed over the main processors 30 belonging to main processor cluster (MPC) 32. The cluster support function 50 enables a software designer to implement application software that is robust against hardware faults in the main processors 30 and against faults attributable to software executing on main processors 30. Moreover, cluster support function 50 facilitates upgrading of application software during run time with little disturbance, as well as changing processing capacity during run time by adding or removing main processors 30 in main processor cluster (MPC) 32.

The main processors 30 of main processor cluster (MPC) 32 execute various programs that result from the loading of respective load modules. A load module is generated by a compiler or similar tool, and contains binary code generated from one or more source code files. Those source code file(s) contain one or more process definitions. The process definitions contain the sequence of source code instructions that are executed in one context as one process thread. The load module is output from the load module generating tool (e.g., compiler) as a file, and the software of the load module is presented to the system as a file.

FIG. 3 shows a load module as a software object which wraps together a group of related potentially executable processes. In particular, FIG. 3 shows an example load module (LM) 60 comprising process definitions 62ₗ-62_{w}, with process definition 62ₗ being the root process definition of the load module (LM) 60. The load module is created when the related process definitions are compiled and linked together.

A program is a running instance of a load module. That is, when a program is created when a load module is loaded into a processor. Thus, a program exists only in run time memory (RAM) of a processor and is created as a consequence of the loading of the corresponding load module. A program can be considered to contain one or more process definitions (corresponding to the processes of the load module whose loading created the program), and is represented in the operating system as a group of process blocks that contain, among other things, a program counter, a stack area, and information regarding running, suspension, and waiting states. The execution of a program can be aborted or suspended by the operating system, and then execution resumed subsequently.

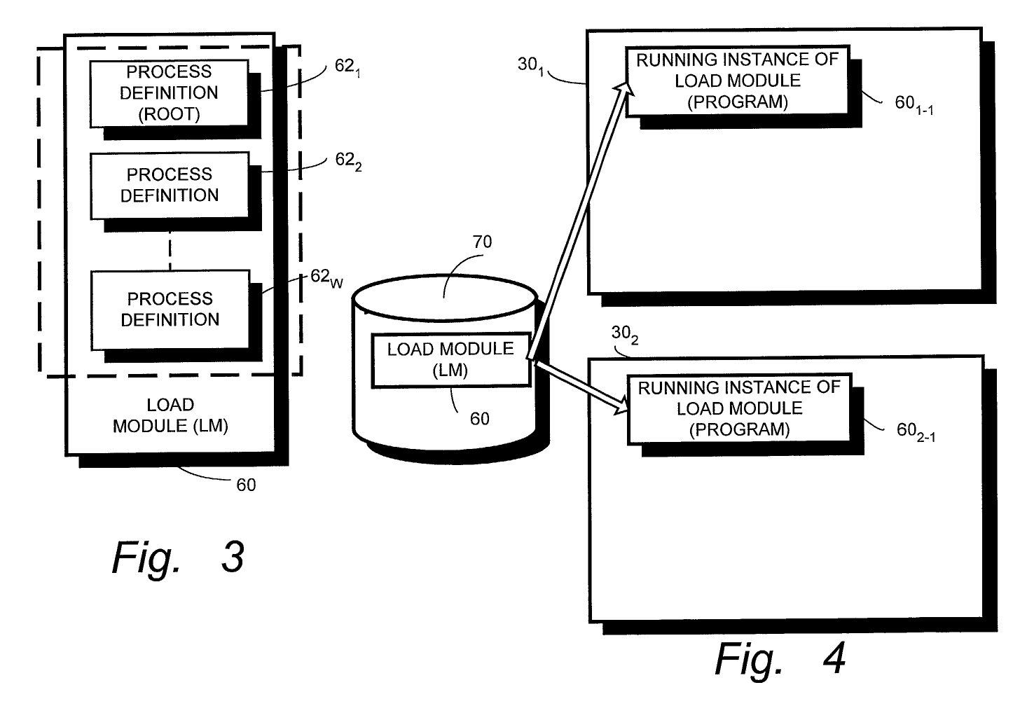

FIG. 4 shows load module 60 as stored in a persistent memory such as a data base 70. In addition, FIG. 4 shows that that load module 60 has been loaded onto processor 301, resulting in creation of a running instance of load module 60, i.e., programs 60ₗ₋ₗ Similarly, load module 60 has been loaded onto processor 30₂, resulting in creation of a running instance of load module 60, i.e., program 60₂₋₁. Other embodiments can permit multiple loads per processor.

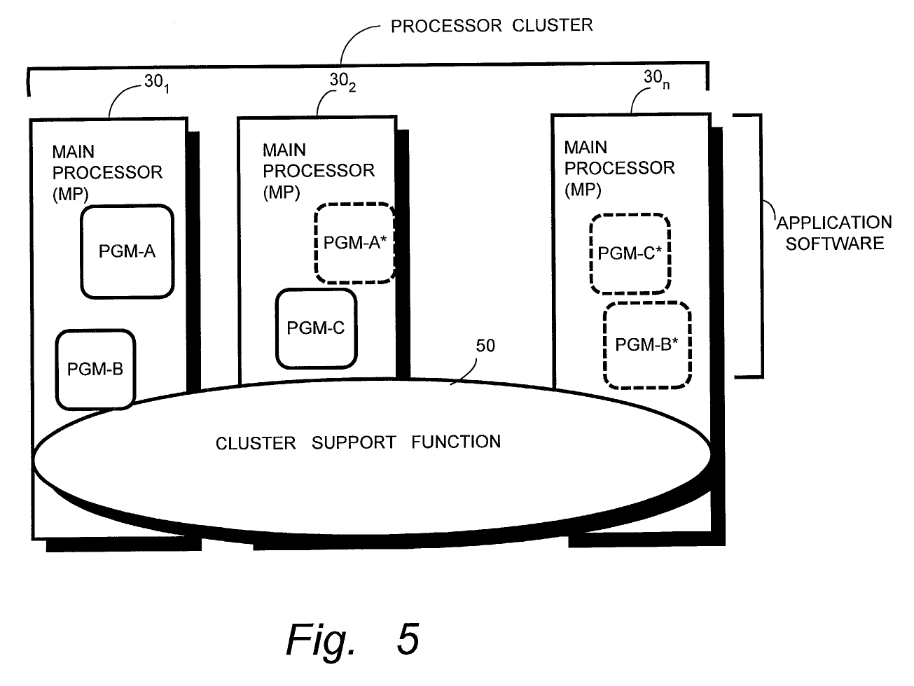

The cluster support function 50 provides support for redundant application software running on the main processor cluster (MPC) 32 using both active and standby programs. In other words, for each load module there is, in reality, a program pair. A first member of the program pair is an active program; a second member of the program pair is a standby program. As illustrated in FIG. 5, the localization of these programs is not constrained to any particular main processors 30. One processor can have both active and standby programs, and the standby programs for programs active on a certain processor can be spread to several other processors.

In the above regard, FIG. 5 shows active programs PGM-A and PGM-B running on main processor 30₁, while active program PGM-C runs on processor 30₂. Standby program PGM-A* (for program PGM-A) runs on processor 30₂. Processor 30ₙ runs standby programs PGM-C* and PGM-B* for programs PGM-C and PGM-B, respectively. The standby programs are denoted in FIG. 5 in broken lines and with asterisk suffixes.

Thus, in accordance with the present invention, the plural programs are distributed to the cluster of processors whereby, for sake of redundancy, at least some of the processors of the cluster have active versions of at least some of the programs and standby versions of others of the programs. Various techniques for distribution of programs are described in U.S. patent application Ser. No. 09/______ (attorney docket: 2380-180), entitled “Software Distribution At A Multi-Processor Telecommunications Platform”, which is incorporated herein by reference.

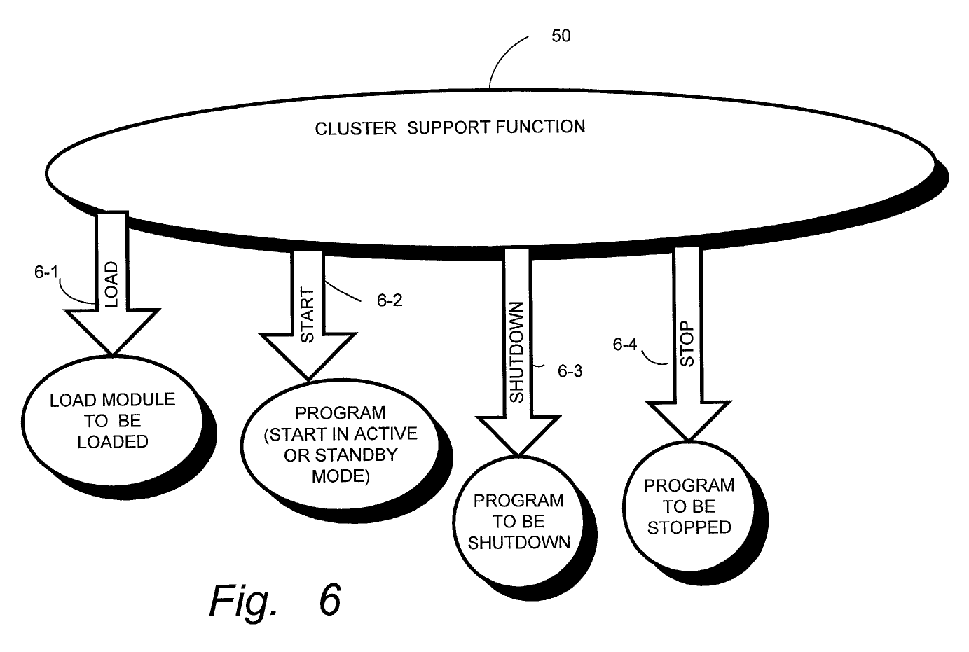

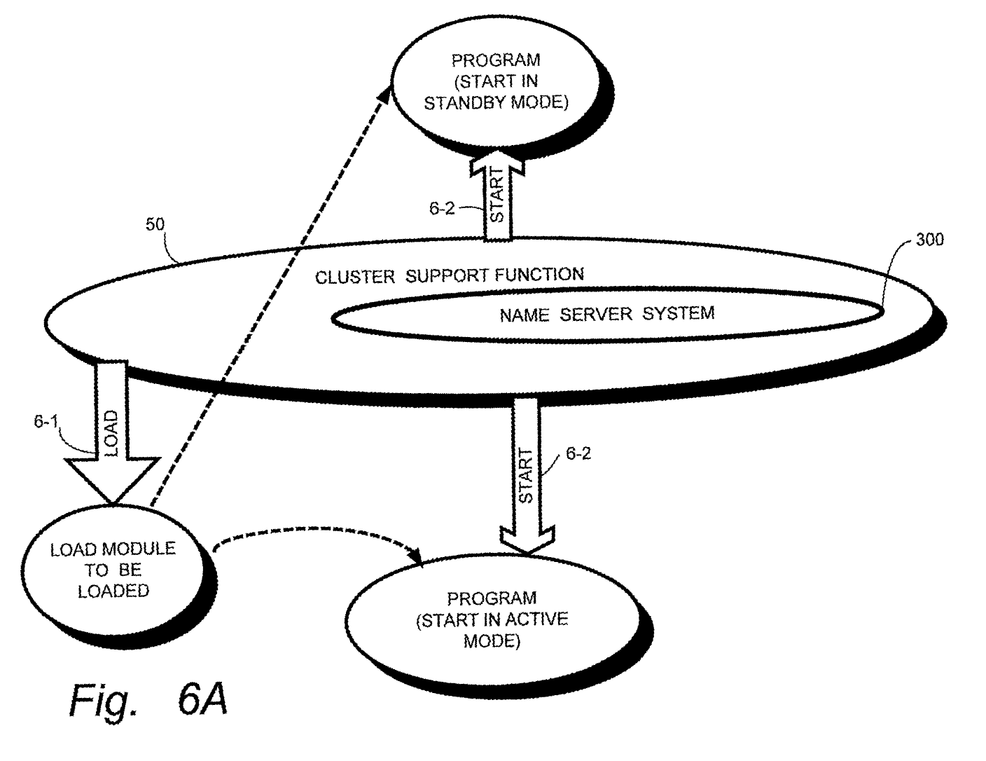

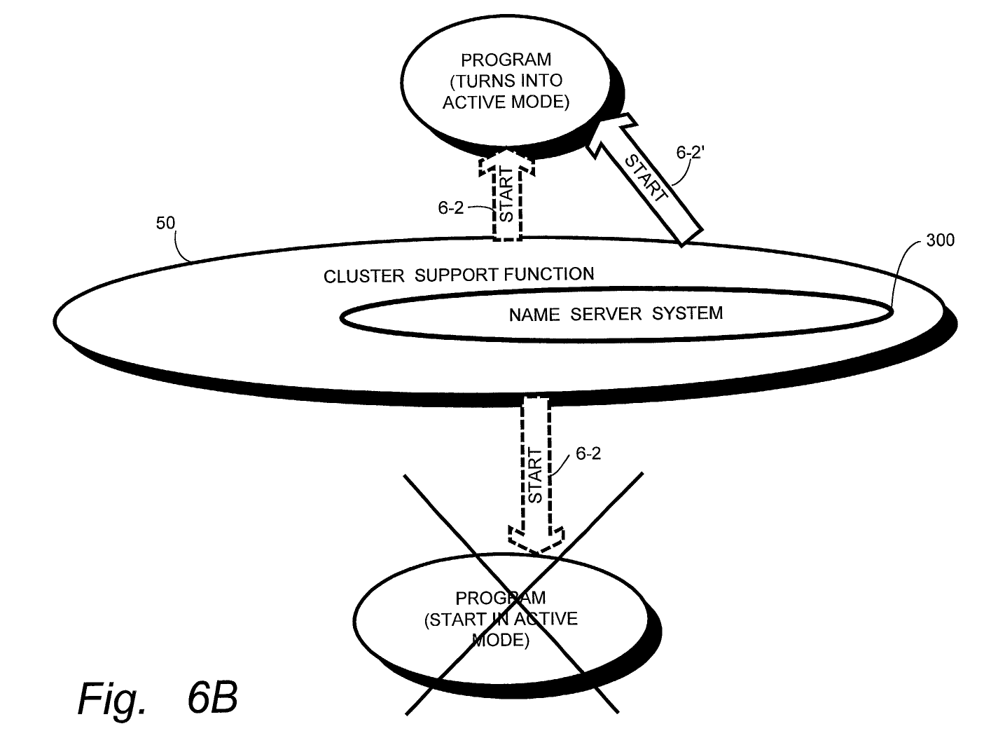

For the present invention, the programs are designed so that cluster support function 50 can load, start, shutdown, and stop them. In this regard, there are certain software hooks in the application software for start and shutdown activities. That is, the application software is always prepared to received the following messages (e.g., in the form of operation system signals): start (or activate); upgrade; and shutdown. The load message and the stop message are implicit messages of which the software itself is unaware. The corresponding activity (e.g., to load a load module and stop a program, respectively) is performed by the operating system. FIG. 6 shows cluster support function 50 sending a load message 6-1 to a load module to be loaded, as well as sending, to differing programs, a start message 6-2; a shutdown message 6-3; and, a stop message 6-4.

In connection with the loading of a load module for creating a program, an operator provides information to the operating system which specifies to which processor 30 a load module shall be loaded to create a running instance of the load module (i.e., a program). In the case of a load module containing software that must be robust, two different processors are specified—one processor to have the active program created using the load module and another processor to have the standby program created from the load module. The operator providing such information triggers load message 6-1, and thus the loading of the load module to create the active program and the standby program, in the manner shown by the two broken lines emanating from the load module in FIG. 6A. The operating system loads the load module to the specified processors by utilizing operating system loading mechanisms. Immediately after and as a consequence of the loading of the load modules, two different programs are created—one for each of the processor specified. See, in this regard, U.S. patent application Ser. No. 09/_______ (attorney docket: 2380-180), entitled “Software Distribution At A Multi-Processor Telecommunications Platform”.

The programs created by the loading of the load module, as their first activity, wait for the start message 6-2 (see FIG. 6A) in order to be activated. The start message 6-2 instructs each program to enter either an active or a standby mode. To start a program the cluster support function 50 uses normal operating system (e.g., OSE-Delta) mechanisms together with an activation hook.

In the case of a program being put in an active mode, the program starts performing its duties. Those duties typically initially include registration in a name server. FIG. 6A shows cluster support function 50 as including name server system 300, which is described in more detail subsequently. In the case of a standby mode, the program waits for a new (e.g., another) start message, as explained below.

The cluster support function 50 and name server 300 will detect any fault occurring in the processor 30 running the active program. For example, the scenario shown in FIG. 6A continues to FIG. 6B, where it is shown that the processor executing the active program fails (as indicated by the crossing out the active program in FIG. 6A). In the case of such failure, the corresponding entry for the active program in name server 300 is removed, and the cluster support function 50 sends another start message (e.g., start message 6-2′) to the standby program. The second start message 6-2′ sent to the standby program in such case advises the standby program that it is now the active or master program. As one of its first tasks, the (former standby) program registers in name server 300 and then starts performing its duties (in the same way as would the former active program).

Thus, as understood from the foregoing, a start/activation message is sent on two different occasions: (1) to an active program essentially immediately after loading (e.g., see start message 6-2 in FIG. 6A); or (2) to a standby program as a consequence of failure or stoppage of the corresponding active program (e.g., see start message 6-2′ in FIG. 6B).

When a program is to be shutdown (see shutdown message 6-3 in FIG. 6), cluster support function 50 uses a software hook to request the software application to prepare its termination. The preparation activities for any particular program depend on nature of the application, but typically involve the following activities: (1) task finalizing; (2) releasing resources; (3) saving state information; (4) closing files; (5) confirming termination preparation; and then (6) terminating execution. On the other hand, when a program is to be stopped (see stop message 6-4 in FIG. 6), the load module is stopped without the benefit of any preparations such as those performed in response to the shutdown message.

When a program is to be upgraded, the termination activities listed above generally must be performed. In addition, the there may be a need to convert certain process data, database schemes, etc., to be compatible with a potential upgrade. Such conversion can be handled in any of several ways. For example, (1) a separate conversion program can be provided; or (2) the new version of the program can include the software for the conversion. In the latter case, there must be a certain convert hook in the program. In any event, the cluster support function 50 ensures that the conversion software, where ever located, is activated at a proper time during the upgrade process. Example upgrade activities are described in more detail in U.S. patent application Ser. No. 09/______ (attorney docket: 2380-183), entitled “Replacing Software At A Telecommunications Platform”, which is incorporated herein by reference.

The main processor cluster (MPC) 32 is one scaleable execution resource intended to be used as a main processing capacity for a telecommunications platform (e.g., telecommunications node). The execution capacity depends upon the number of processors 30 within the main processor cluster (MPC) 32. In case of change of requirements, the present invention facilitates an easy change of the number of processors 30 comprising main processor cluster (MPC) 32 and reconfiguring of the load module localization.

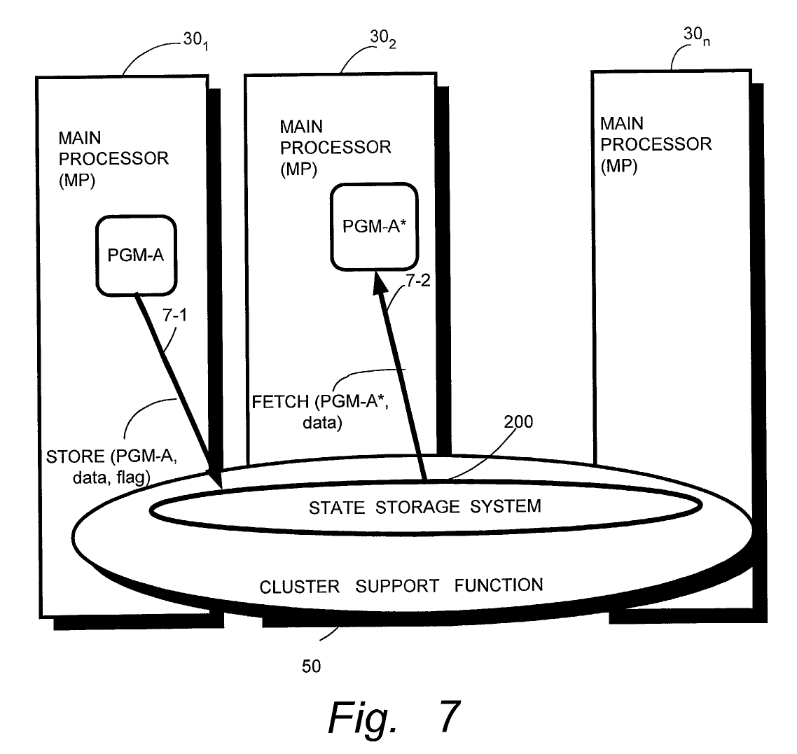

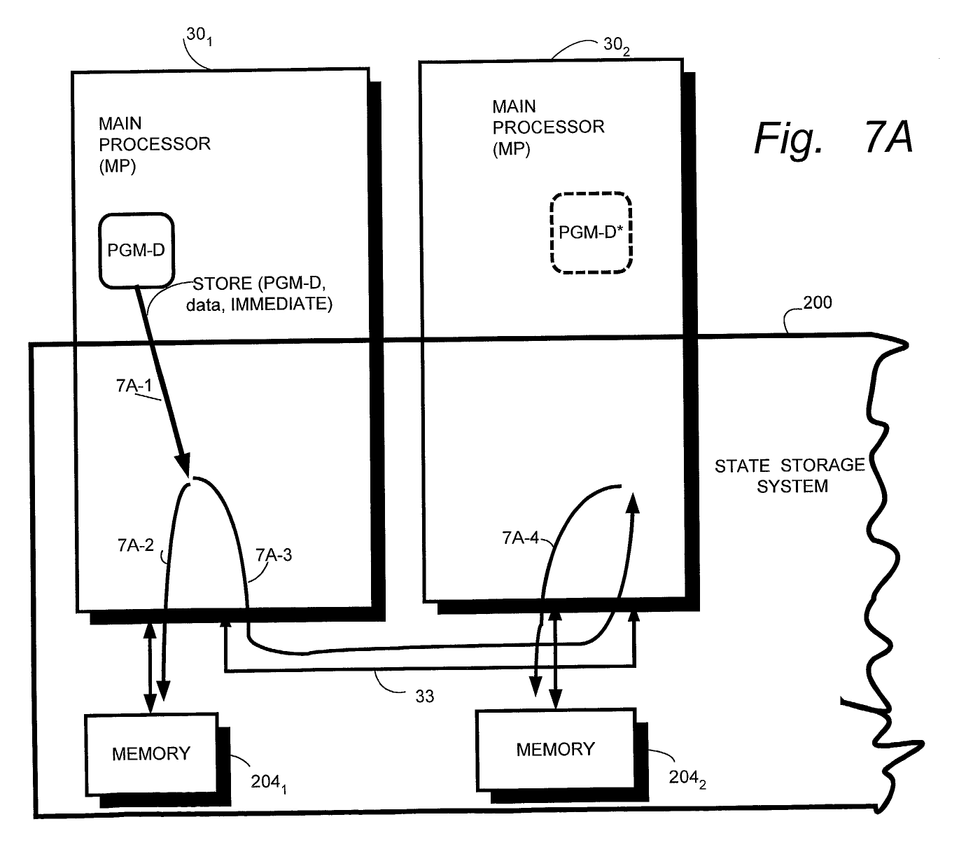

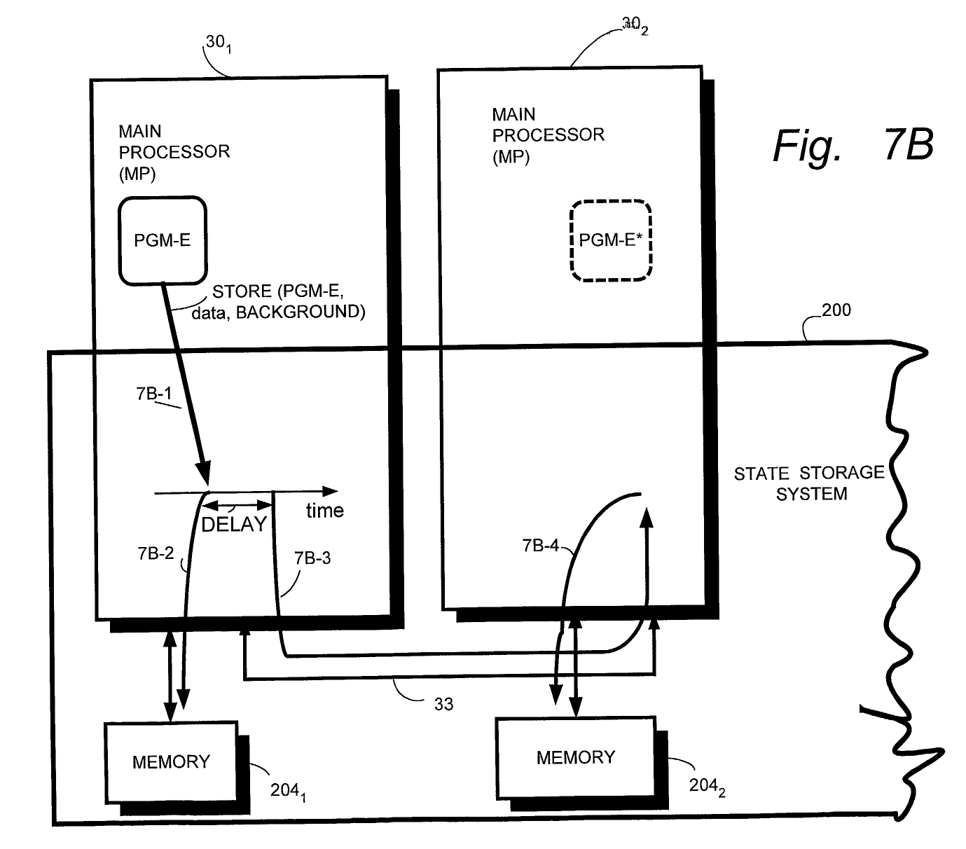

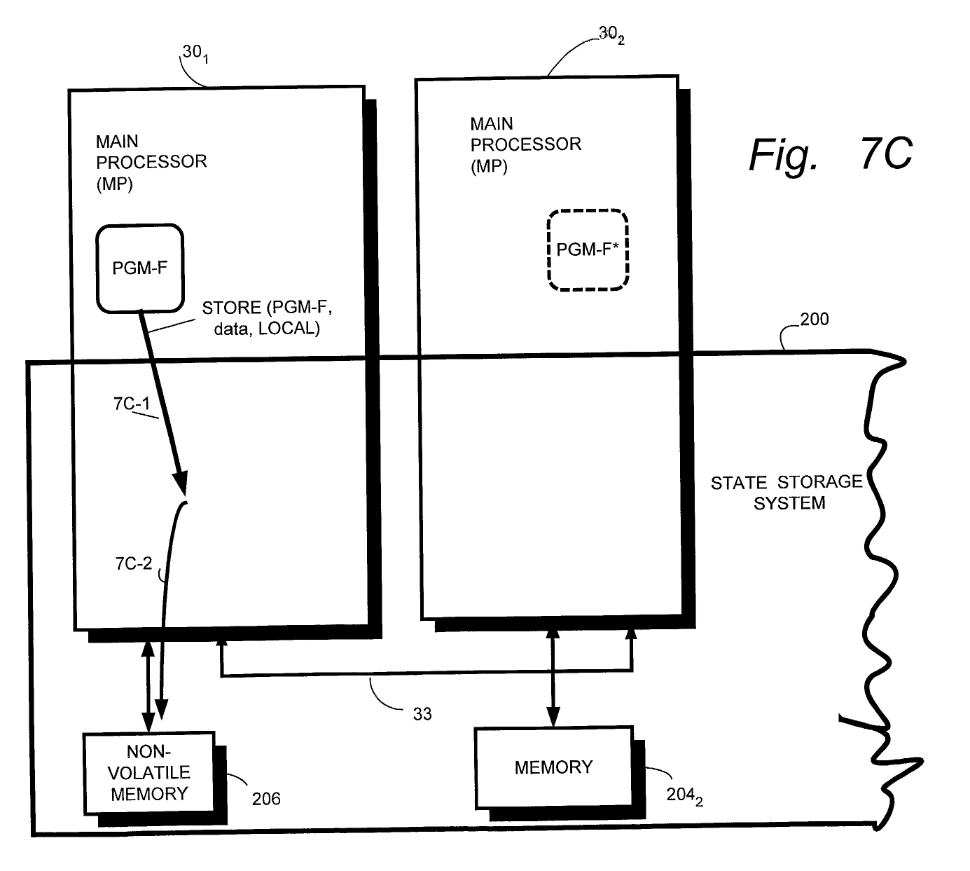

As shown in FIG. 7, the cluster support function 50 of main processor cluster (MPC) 32 includes a state storage system 200. The state storage system 200 is used for a program to store important data utilized during execution of an active program in case of failure of the processor executing that active program. It is the program itself that decides what data to store and when to store such data (e.g., preferably when critical data has changed value), all depending on what data is needed to resume operation in a suitable way after a disturbance. The stored data can be utilized in two different situations. A first situation occurs when a processor (and/or program) is restarted, likely due to a software error. A second situation occurs when a hardware fault is detected and the processor is taken out of operation. In the first situation, the program that stored the data in the state storage system 200 is restarted and will then fetch the data from the state storage system 200 and thereafter continue execution at the point indicated by the newly fetched state. In the second situation, a standby version of the program (e.g., the standby program) will be activated (see, e.g., start message 6-2′ in FIG. 6B) on another processor, with the standby program fetching the data from state storage system 200 and resuming operation of the program on the other processor.

Thus, the present invention allows a software application to continue its task on a different processor than that on which it began execution (as may occur upon a failure of a processor). To do so, the cluster support function 50 of the present invention makes it possible to transfer the current state of the software from the first processor to a second processor continuously. It is the state storage system 200 of cluster support function 50 that ensures that data stored at a first processor can be retrievable by any requesting processor (including the first processor). It is state storage system 200 that replicates data stored on one processor to another processor if the storing program is part of a redundant pair of programs according to the software configuration of the data system.

As an example of the foregoing, FIG. 7 shows by action 7-1 that program PGM-A is storing data to state storage system 200. The store operation of action 7-1 includes an identification of the program making the store; the data to be stored; and a storage mode indicator. In accordance with one scenario of the invention, if the processor 30₁ executing program PGM-A were to fail, then the standby program PGM-A* executing on processor 302 would be able to fetch the stored information (indicated by fetch action 7-2 in FIG. 7) and continue the execution. Thus, standby version of program (e.g., PGM-A*) executing on a second processor (processor 30₂) is provided with the state data of the event-affected program PGM-A for resumption of operation of the event-effected load module.

In accordance with one mode of the invention illustrated in FIG. 7A, at a time indicated by event 7A-1 the active version of the program (e.g., PGM-D) requests immediate (e.g., secure) storage of its state data both in a memory accessible by its processor (processor 30₁) and in a memory accessible by the processor of the cluster having the standby version of the program (e.g., processor 302 which has standby load module PGM-D*). The program PGM-D indicates the immediate storage mode by setting the mode flag in the store operation instruction to a value indicative of immediate storage (“IMMEDIATE”). FIG. 7A particularly shows state storage system 200, upon receipt of the store operation instruction 7A-1, sending instructions to store the data included in store operation instruction 7A-1 both in memory 204₁ (accessible by processor 30₁) and memory 204₂ (accessible by processor 30₂). In this regard, as event 7A-2 the state storage system 200 stores the state data from program PGM-D in memory 2041, and as event 7A-3 the portion of processor 30₁ comprising state storage system 200 sends a command over inter-processor communication link 33. The command of event 7A-3 requests the portion of processor 30₂ comprising state storage system 200 to store the state data in memory 204₂, which processor 30₂ does as event 7A-4. Thus, the immediate storage mode essentially performs storage of the state data for the program in parallel fashion in memories accessible by both processor 30₁ and processor 30₂. Although unillustrated in FIG. 7A, when both instances of storage are completed a synchronous acknowledgment signal is sent to the program that requested the storage, i.e., a synchronous response to event 7A-1.

Another state data storage mode of the invention, the background replication mode, is illustrated in FIG. 7B. Upon the occurrence of the predetermined event, as event 7B-1 the active version of the load module (e.g., PGM-E) requests background replication of its state data. The load module PGM-E indicates the immediate storage mode by setting the flag in the store operation instruction to a value indicative of the background replication (“BACKGROUND”). As in the mode of FIG. 7A, immediately upon receipt of the store operation instruction 7B-1, the state storage system 200 sends instructions to store the data included in store operation instruction 7B-1 to memory 20₁ (accessible by processor 30₁). The storage in memory 204₁ is performed as event 7B-2. Then, state storage system 200 waits until it is suitable (with respect to the overall execution situation of the processor) before sending command 7B-3 to store the data included in store operation instruction 7B-1 in memory 204₂ (accessible by processor 30₂). After the store command 7B-3 is sent over inter-processor communication link 33, the portion of processor 30₂ comprising state storage system 200 stores the state data in memory 204₂ as event 7A-4. Thus, the background replication mode essentially in delayed sequence stores the state data for the load module, first storing the state data in a memory accessible by the processor currently executing the active version of the program, and then in a memory accessible by another processor (e.g., a processor which would execute the standby version of the program when such standby version of the program is activated). The event 7B-1 is synchronously acknowledged in this background replication mode immediately after the storage 7B-2.

For the immediate replication state data storage mode of FIG. 7A and the background replication mode of FIG. 7B, the memories 204₁ and 204₂ can be any memory having sufficient access speed, for which a RAM is an example.

A further state data storage mode of the invention, the LOCAL mode, is illustrated in FIG. 7C. Upon the occurrence of the predetermined event, as event 7C-1 the active version of the program (e.g., PGM-F) requests local storage of its state data. The program PGM-F indicates the local mode by setting the flag in the store operation instruction to a value indicative of local storage (“LOCAL”). As in the mode of FIG. 7A and FIG. 7B, immediately upon receipt of the store operation instruction 7C-1, the state storage system 200 sends instructions to store the data included in store operation instruction 7C-2. However, in the LOCAL mode the memory utilized is preferably a non-volatile memory 206 which will not be destroyed upon restart of processor 30₁. Moreover, in the LOCAL mode there is no instruction to save the store data of the load module in a memory accessible by any other processor.

Thus, the active version of the program PGM sends its state data and a storage mode flag to state storage system 200. As explained above with respect to FIG. 7A, FIG. 7B, and FIG. 7C, respectively, the storage mode flag requests at least one of the following:

(1) [IMMEDIATE REPLICATION mode] storing the state data in parallel in both a memory accessible by the first processor of the cluster and in a memory accessible by a second processor of the cluster.

(2) [BACKGROUND REPLICATION mode] essentially immediate storing of the state data in a memory accessible by the first processor of the cluster followed by delayed storing of the state data in a memory accessible by a second processor of the cluster;

(3) [LOCAL mode] storing the state data in a non-volatile memory accessible by the first processor of the cluster.

The application software is designed so that the application software itself knows what data needs to be stored in state storage system 200, and which of the save modes is to be implemented for that particular program.

Moreover, it should be realized that a program may utilize one or more of the storage modes. For example, a program may have some of its save operations performed with respect to a first set of state data in accordance with the immediate replication storage mode, while other save operations for the same program may be performed with respect to the first set (or a second set) of state data in accordance with the local replication mode. Thus, the application software can itself decide and dictate what state data is relevant to store locally (e.g., to be retrieved after a restart), and what state data is to be distributed to another processor (e.g., to be retrieved after a take over).

A program stores its state data to the state storage system 200 as soon as data that is critical for the state of the program is changed. The change may occur due to an event which is internal or external to the program which requests the save.

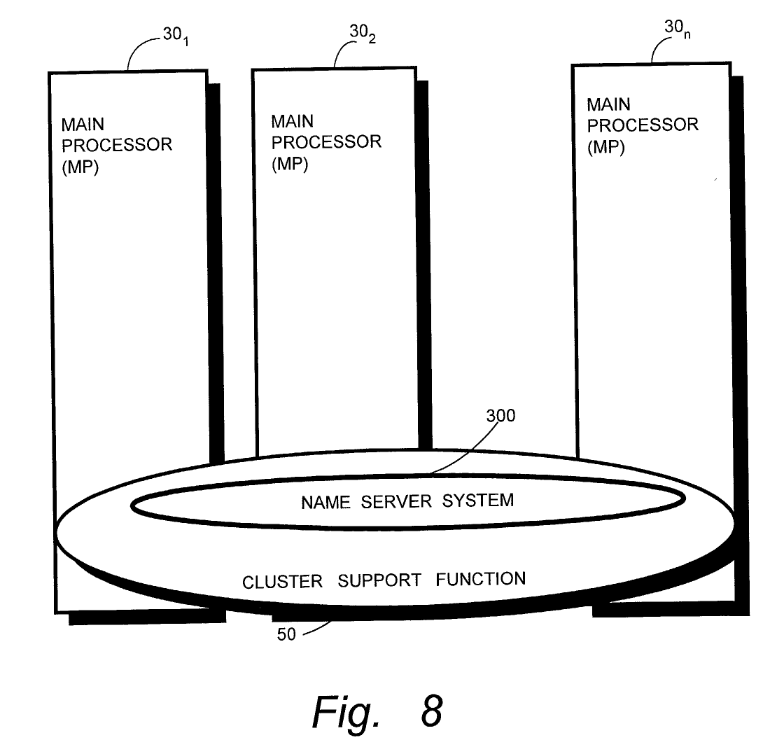

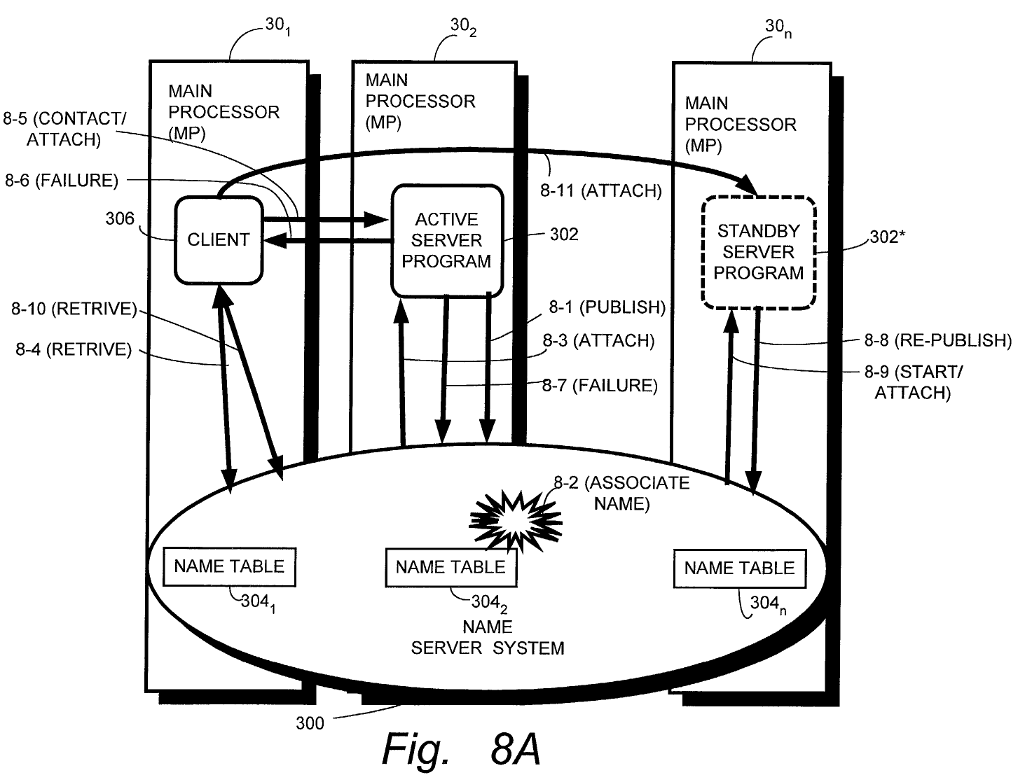

As shown in FIG. 8 as well as FIG. 6A and FIG. 6B described earlier, in one aspect the cluster support function 50 of main processor cluster (MPC) 32 includes name server system 300. As explained herein, upon publication of a design name of the load module (i.e., the load module which was used to create the program), the name server system 300 associates a run time name for the program (used to identify the program) with the design name and supervises starting of the program.

In the context of the name server system 300 of FIG. 8, reference is made to a server program. A server program is a program which can be utilized by client processes or programs executing on the same or another processor of main processor cluster (MPC) 32.

As explained above, when a load modules is loaded to a processor, a run-time name or run-time reference is assigned to the program. Knowledge of the run-time name or run-time reference is necessary for one program to contact another program. But when a client program is started on a processor, it is impossible for the client program, for example, to know in advance what is the run-time name for a certain server program which the client wishes to utilize. The difficulty is even more complex in a multi-processing environment such as main processor cluster (MPC) 32, in which it is not known in advance upon which processor 30 a program may execute, or in which programs may move around from one processor to another (e.g., in the case of a take over of the program by another processor, which can occur upon fault of a first processor, etc.).

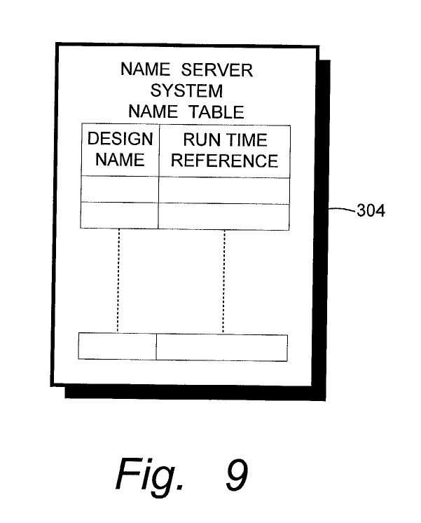

FIG. 8A illustrates a scenario of utilization of name server system 300. After being loaded upon processor 30₂, as event 8-1 an active server program 302 publishes its design name to name server system 300 for sake of registering its existence and design name with name server system 300. When the registration is executed, as event 8-2 name server system 300 associates the run time reference with the published design name. Upon assigning a run time reference to active server program 302, name server system 300 creates an entry (record) for active server program 302 in a name table maintained by name server system 300. An example name table 304 is shown in FIG. 9, showing records which correlate the published design name and the run time reference.

After associating the design name with the run time reference for active server program 302, as event 8-3 the name server system 300 begins supervising active server program 302.

In the scenario of FIG. 8A, client 306 is shown as already executing on processor 301. When client 306 needs access to active server program 302, as event 8-4 the client 306 can retrieve the run time reference for active server program 302. The client 306 knows the design name for active server program 302, and using the design name the client 306 can obtain from name server system 300 the run time reference for active server program 302. Then, knowing the run time reference of active server program 302, as event 8-5 client 306 can contact and supervise active server program 302.

The scenario of FIG. 8A further shows that execution of the server program is moved from processor 30hd 2 to processor 30ₙ. In particular, the standby server program 302* is invoked and executed on processor 30ₙ in lieu of execution of active server program 302 on processor 30₂. Such move could be occasioned, for example, by failure of processor 30₂. In any event, because client 306 is supervising active server program 302, as event 8-6 client 306 detects failure or unavailability of active server program 302.

When the server program is moved from processor 30₂ to processor 30ₙ, the failure or unavailability of active server program 302 is also detected by name server system 300 (event 8-7), since name server system 300 is supervising execution thereof.. Upon such failure/unavailability detection, name server system 300 removes the record corresponding to active server program 302 from its name table 304.

When it migrates to processor 30ₙn, the server program must again (as event 8-8) re-publish its design name to name server system 300. That is, the activated standby server program 302* must publish its design name to name server system 300. In response to such publication, name server system 300 creates another record in name table 304, this time a record for standby server program 302*. As with event 8-3, as event 8-9 name server system 300 starts supervising standby server program 302*.

Needing still to access the server program, as action 8-10 client 306 again must ask name server system 300 for the run time reference for the server program. At event 8-10 the client 306 again uses the design name of the server program in requesting the run time reference from name server system 300. When the re-registration of standby server program 302* has been completed, as part of event 8-10 the client 306 receives the run time reference for standby server program 302*. Thereafter, as reflected by event 8-11, the client 306 can again communicate the server program, e.g., standby server program 302*. In FIG. 8A, event 8-11 is shown as an attachment, which is a request primitive that initiates the supervising of the execution of another program.

Thus, it is understood from the scenario of FIG. 8A how client 306 can retrieve the run time reference (name) of the server program from name server system 300 for contacting and supervising the server program. Moreover, name server system 300 detects when the server program has moved from a first processor (e.g., processor 30₂) to a second processor (processor 30ₙ). In such instance, the relocated server program must register its new active version (the former standby version) in the name server system 300. The client 306 can then request the new run time reference of the server program (e.g., standby server program 302*) from name server system 300, and smoothly continue operation.

Thus, advantageously, a selected processor of the cluster or program can be removed without shutting down the entire platform (e.g., node). Active versions of programs executing on the selected processor are terminated while standby versions thereof are rendered as active versions. In such circumstances, name server system 300 facilitates continued access to programs running on main processor cluster (MPC) 32 by providing valid run time references of the software.

In connection with FIG. 8A, it will be understood that the portion of each processor 30 comprising name server system 300 has its own copy of name table 304.

The respective copies of name table 304 are updated using update messages sent over inter-processor communication link 33.

The main processor cluster (MPC) 32 of the present invention therefore can be equipped with an appropriate number of processors, e.g., not more or less than needed.

The main processor cluster (MPC) 32 can be operated with just a few processors, to as many as twenty or thirty processors or more. In fact, the main processor cluster (MPC) 32 can be configured with an optimum number of processors by dynamic removal or addition of processors, without shutting down the platform. Optimally configured, the platform is more cost effective to implement and operate.

Moreover, the main processor cluster (MPC) 32 of the present invention provides the application software with mechanisms that enable the application to be fault tolerant. In this regard, the state storage system 200 of the present invention facilitates switch over of programs from one processor to another. In addition, the name server system 300 assists in assigning run time references upon such switch overs.

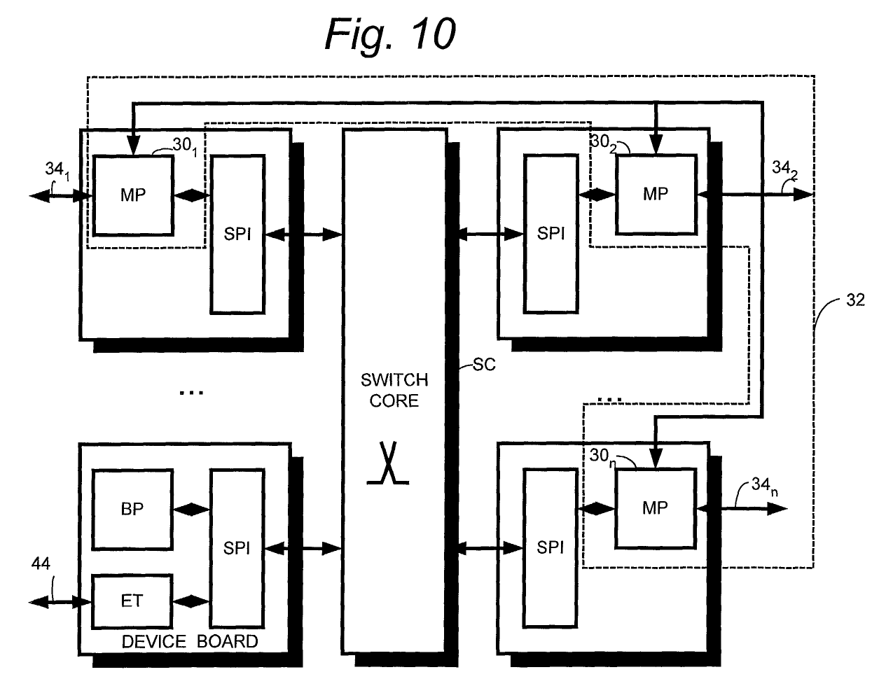

FIG. 10 shows one example embodiment of a ATM switch-based telecommunications platform having the cluster support function 50, including state storage system 200 and name server system 300. In the embodiment of FIG. 10, each of the main processors 30 comprising main processor cluster (MPC) 32 are situated on a board known as a main processor (MP) board. The main processor cluster (MPC) 32 is shown framed by a broken line in FIG. 10. The main processors 30 of main processor cluster (MPC) 32 are connected through a switch port interface (SPI) to a switch fabric or switch core SC of the platform. All boards of the platform communicate with each other via the switch core SC. All boards are equipped with a switch port interface (SPI). The main processor boards further have a main processor module. Other boards, known as device boards, have different devices, such as extension terminal (ET) hardware or the like. All boards are connected by their switch port interface (SPI) to the switch core SC.

Whereas the platform of FIG. 10 is a single stage platform, it will be appreciated by those skilled in the art that the main processor cluster (MPC) of the present invention can be realized in multi-staged platforms. Such multi-stage platforms can have, for example, plural switch cores (one for each stage) appropriately connected via suitable devices. The main processors 30 of the main processor cluster (MPC) 32 can be distributed throughout the various stages of the platform, with the same or differing amount of processors (or none) at the various stages.

Various aspects of ATM-based telecommunications are explained in the following: U.S. patent applications Ser. No. 09/188,101 [PCT/SE98/02325] and SN 09/188,265 [PCT/SE98/02326] entitled “Asynchronous Transfer Mode Switch”; U.S. patent application Ser. No. 09/188,102 [PCT/SE98/02249] entitled “Asynchronous Transfer Mode System”, all of which are incorporated herein by reference.

As understood from the foregoing, the present invention is not limited to an ATM switch-based telecommunications platform, but can be implemented with other types of multi-processor systems. Moreover, the invention can be utilized with single or multiple stage platforms. Aspects of multi-staged platforms are described in U.S. patent application Ser. No. 09/249,785 entitled “Establishing Internal Control Paths in ATM Node” and U.S. patent application Ser. No. 09/213,897 for “Internal Routing Through Multi-Staged ATM Node,” both of which are incorporated herein by reference.

The present invention applies to many types of apparatus, such as but not limited to) telecommunications platforms of diverse types, including (for example) base station nodes and base station controller nodes (radio network controller [RNC] nodes) of a cellular telecommunications system. Example structures showing telecommunication related elements of such nodes are provided, e.g., in U.S. patent application Ser. No. 09/035,821 [PCT/SE99/00304] for “Telecommunications Inter-Exchange Measurement Transfer,” which is incorporated herein by reference.

Various other aspects of cluster support function 50 are described in the following, all of which are incorporated herein by reference: (1) U.S. patent application Ser. No. 09/467,018 filed Dec. 20, 1999, entitled “Internet Protocol Handler for Telecommunications Platform With Processor Cluster”; (2) U.S. patent application Ser. No. 09/______ (attorney docket: 2380-180), entitled “Software Distribution At A Multi-Processor Telecommunications Platform”; (3) U.S. patent application Ser. No. 09/______ (attorney docket: 2380-183), entitled “Replacing Software At A Telecommunications Platform”.

The actions illustrated in FIG. 6 are just examples of differing kinds of communications that can be issued from cluster support function 50 to a program. In fact, in one embodiment of the invention, these actions are more like a method which act on the load module entity, and are fully supported by operating system mechanisms so that the load module involved does not have to take them into consideration. The activate and shutdown messages are signals sent from the cluster support function 50 to the program. The program, therefore, must contain software hooks/receive statements for these messages/signals.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A telecommunications platform comprising a cluster of processors which perform a platform central processing function, the platform central processing function including cluster support function distributed to the cluster of processors and plural programs, the plural programs being distributed to the cluster of processors whereby, for sake of redundancy, at least some of the processors of the cluster have an active version of at least some of the programs and another version of others of the programs.

2. The apparatus of claim 1, wherein the plural programs are dynamically distributed to the processors of the cluster.

3. The apparatus of claim 1, wherein the cluster support function comprises a state storage system, and wherein an active version of an event-affected program executing on a first processor of the cluster stores state data in the state storage system, the state data being sufficient for at least one of the following:
(1) another version of the program to resume operation on a second processor using the state data stored in the state storage system;
(2) for the active version of the program to restart using the state data stored in the state storage system.

4. The apparatus of claim 3, wherein the another version of the program resumes operation in event of upgrade or shutdown of the active version of the program, wherein the another version of the program is a standby version thereof executing on a second processor of the cluster, wherein the state data of the program is provided to the standby version of the program for resumption of operation of the program.

5. The apparatus of claim 3, wherein the another version of the program is a standby version thereof executing on a second processor of the cluster, wherein the state data of the program is provided to the standby version of the program for resumption of operation of the program.

6. The apparatus of claim 5, wherein the program stores state data in the state storage system.

7. The apparatus of claim 3, wherein the active version of the program stores the state data in parallel in both a memory accessible by the first processor of the cluster and in a memory accessible by a second processor of the cluster.

8. The apparatus of claim 3, wherein the active version of the program stores the state data essentially immediately in a memory accessible by the first processor of the cluster; and then has a delayed storing of the state data in a memory accessible by a second processor of the cluster.

9. The apparatus of claim 3, wherein the active version of the program stores the state data in a non-volatile memory accessible by the first processor of the cluster.

10. The apparatus of claim 3, wherein the program sends a storage mode flag to the state storage system, and wherein the storage condition flag requests at least one of the following:
(1) storing the state data is stored in parallel in both a memory accessible by the first processor of the cluster and in a memory accessible by a second processor of the cluster;
(2) essentially immediate storing of the state data in a memory accessible by the first processor of the cluster followed by delayed storing of the state data in a memory accessible by a second processor of the cluster;
(3) storing the state data in a non-volatile memory accessible by the first processor of the cluster.

11. The apparatus of claim 1, wherein the cluster support function comprises a name server system, and wherein upon publication of a design name of a program of the program, the name server system associates a run time name with the design name of the program and supervises starting of the program.

12. The apparatus of claim 11, wherein the program is a server program, wherein a client program can retrieve the run time name of the server program from the name server system, and wherein the client program uses the run time name of the server program to contact and supervise the server program.

13. The apparatus of claim 12, wherein the name server system detects when the server program moves from a first processor to a second processor of the cluster.

14. The apparatus of claim 12, wherein when the server program moves from a first processor to a second processor of the cluster, the server program obtains a new run time name from the name server system and the client program requests the new run time name of the server program from the name server system.

15. The apparatus of claim 1, wherein a selected processor of the cluster can be removed without shutting down the platform by terminating active versions of programs executing on the selected processor and rendering the standby versions thereof as active versions.

16. A method of operating a telecommunications platform comprising:
configuring plural processors in a cluster for performing a platform central processing function;
distributing a cluster support function to the plural processors of the cluster;
distributing plural programs to the processors of the cluster whereby, for sake of redundancy, at least some of the processors of the cluster have an active version of at least some of the programs and another version of others of the programs.

17. The method of claim 16, further comprising dynamically distributing the plural programs to the processors of the cluster.

18. The method of claim 16, further comprising storing state data of an active version of a program executing on a first processor in a state storage system; and thereafter either:
(1) resuming operation of the program on a second processor using the state data stored in the state storage system;
(2) restarting the active version of the program on the first processor using the state data stored in the state storage system.

19. The method of claim 18, wherein the resuming operation of the program occurs upon one of upgrade or shutdown of the active version of the program, and wherein the resuming operation of the program comprises using a standby version of the program executing on the second processor.

20. The method of claim 18, wherein the resuming operation of the program comprises using a standby version of the program executing on the second processor.

21. The method of claim 18, wherein the step of storing the state data is performed.

22. The method of claim 18, wherein the step of storing the state data is stored in parallel in both a memory accessible by the first processor of the cluster and in a memory accessible by a second processor of the cluster.

23. The method of claim 18, wherein the step of storing the state data includes:
(1) essentially immediately storing the state data in a memory accessible by the first processor of the cluster; and then
(2) delayed storing of the state data in a memory accessible by a second processor of the cluster.

24. The method of claim 18, wherein the step of storing the state data includes storing the state data in a non-volatile memory accessible by the first processor of the cluster.

25. The method of claim 18, further comprising the program sending a storage mode flag to the state storage system, and wherein the storage condition flag requests at least one of the following:
(1) storing the state data is stored in parallel in both a memory accessible by the first processor of the cluster and in a memory accessible by a second processor of the cluster;
(2) essentially immediate storing of the state data in a memory accessible by the first processor of the cluster followed by delayed storing of the state data in a memory accessible by a second processor of the cluster;
(3) storing the state data in a non-volatile memory accessible by the first processor of the cluster.

26. The method of claim 16, further comprising:
publishing a design name of a program of a loaded program;
using a distributed name server to associate a run time name with the design name of the program and supervise starting of the program.

27. The method of claim 27, wherein the program is a server program, and further comprising:
a client program retrieving the run time name of the server program from the name server system;
the client program using the run time name of the server program to contact and supervise the server program.

28. The method of claim 27, further comprising the name server detecting when the server program moves from a first processor to a second processor of the cluster.

29. The method of claim 27, further comprising:
moving the server program from a first processor to a second processor of the cluster;
the server program obtaining a new run time name from the name server system; and
the client program requesting the new run time name of the server program from the name server system.

30. The method of claim 16, further comprising removing a selected processor of the cluster without shutting down the platform by terminating active versions of programs executing on the selected processor and rendering the standby versions thereof as active versions.
